(19) United States
(12) Patent Application Publication
(10) Pub. No.: US 2019/0042653 A1
(43) Pub. Date: Feb. 7, 2019

(54) AUTOMATIC IDENTIFICATION OF USER INFORMATION

(71) Applicant: PayPal, Inc., San Jose, CA (US)

(72) Inventors: Cheng Tian, San Jose, CA (US); Michael Charles Todasco, Santa Clara, CA (US)

(73) Assignee: PayPal, Inc.

(21) Appl. No.: 15/668,415

(22) Filed: Aug. 3, 2017

(51) Int. Cl. G06F 17/30; H04L 29/06; G06Q 20/38

(52) U.S. Cl. CPC G06F 17/30867; G06Q 20/3821; H04L 63/102

(57) ABSTRACT

A computer system of a first entity determines that one or more types of information are required for registering a user for a service associated with a service provider. The computer system configures a selectable user interface element to: upon selection, analyze electronic content in one or more databases associated with a second set of entities to identify, from the electronic content, one or more values associated with the user, the one or more values corresponding to the one or more types of information, and wherein the first entity is different from the second set of entities; and further cause the one or more values to be transmitted to the service provider.

### TECHNICAL FIELD

The present disclosure relates generally to user information, and more particularly to analyzing content to automatically identify user information.

### BACKGROUND

In today's age, there is a large amount of online services and platforms for a user to utilize. However, oftentimes, the user has to individually sign up and input user information in order to utilize each service or platform. This can be quite time consuming for a consumer and potentially be enough of a deterrent to keep a user from signing up for a particular service. It would be advantageous to provide a simpler solution, such as an automated solution, so that a user signing for up for a service or multiple services does not have to repeatedly input user information.

### BRIEF DESCRIPTION OF THE DRAWINGS

FIG. 1 illustrates an identification system, in accordance with an embodiment.

FIG. 2 is a flowchart illustrating the operations of the identification program of FIG. 1 in creating a selectable user interface element for automating registration of a user with a service provider, in accordance with an embodiment.

FIG. 3 is a flowchart illustrating the operations of the identification program of FIG. 1 in identifying one or more values corresponding to the one or more types of information required for registration of the service associated with a service provider server, in accordance with an embodiment.

FIG. 4 is a flowchart illustrating an alternative embodiment of the operations of the identification program of FIG. 1 in creating a selectable user interface element for automating registration of a user with a service provider, in accordance with an embodiment.

FIG. 5 illustrates an alternative embodiment of the identification system, in accordance with an embodiment.

FIG. 6 is a block diagram depicting the hardware components of the identification system of FIGS. 1 and 5, in accordance with an embodiment.

### DETAILED DESCRIPTION

Embodiments of the present disclosure provide a system, method, and program product. A computer system of a first entity determines that one or more types of information are required for registering a user for a service associated with a service provider. The computer system configures a selectable user interface element to: upon selection, analyze electronic content in one or more databases associated with a second set of entities to identify, from the electronic content, one or more values associated with the user, the one or more values corresponding to the one or more types of information, and wherein the first entity is different from the second set of entities; and further cause the one or more values to be transmitted to the service provider.

In the example embodiment, the present disclosure describes a solution to the problem of the need for a user to enter user information when signing up for a service, which in some cases may prevent a user from signing up for a particular service. The present solution describes a solution that includes automatically identifying user information within electronic content that can be utilized for creating a selectable element that contains the information needed to sign up for a specific service, application or platform. In the example embodiment, the present disclosure further describes presenting the selectable element to a user of a computing device, and further based on selection of the selectable element, causing a transmission of the identified user information to a service provider server. Upon reception of the identified user information, service provider server may automatically sign the user up for the specific service, application, or platform without requiring the user to input the user information (or at least minimizing the amount of user information that the user has to input).

In other embodiments, the present disclosure describes a solution that includes identifying that one or more types of information are needed for registration for a particular service, and further configuring a selectable user interface element to identify the one or more types of information upon selection. The present disclosure further describes transmitting the selectable user interface element for the purposes of presentation to a user of a computing device. The present disclosure further describes upon selection of the selectable user interface element, identifying one or more values corresponding to the one or more types of information and further causing transmission of the one or more values to a service provider associated with the registration.

Embodiments of the present disclosure will now be described in detail with reference to the accompanying Figures.

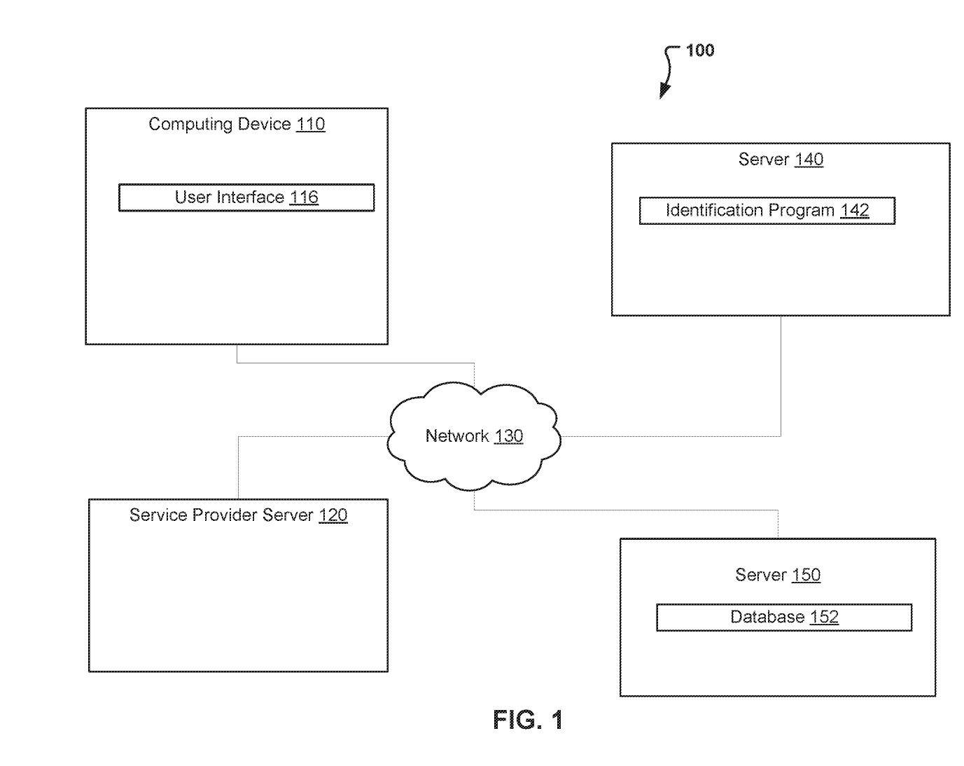

FIG. 1 illustrates an identification system 100, in accordance with an embodiment. In the example embodiment, identification system 100 includes computing device 110, server 140, server 150, and service provider server 120 interconnected via network 130.

In the example embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between computing device 110, service provider server 120, server 140, and server 150.

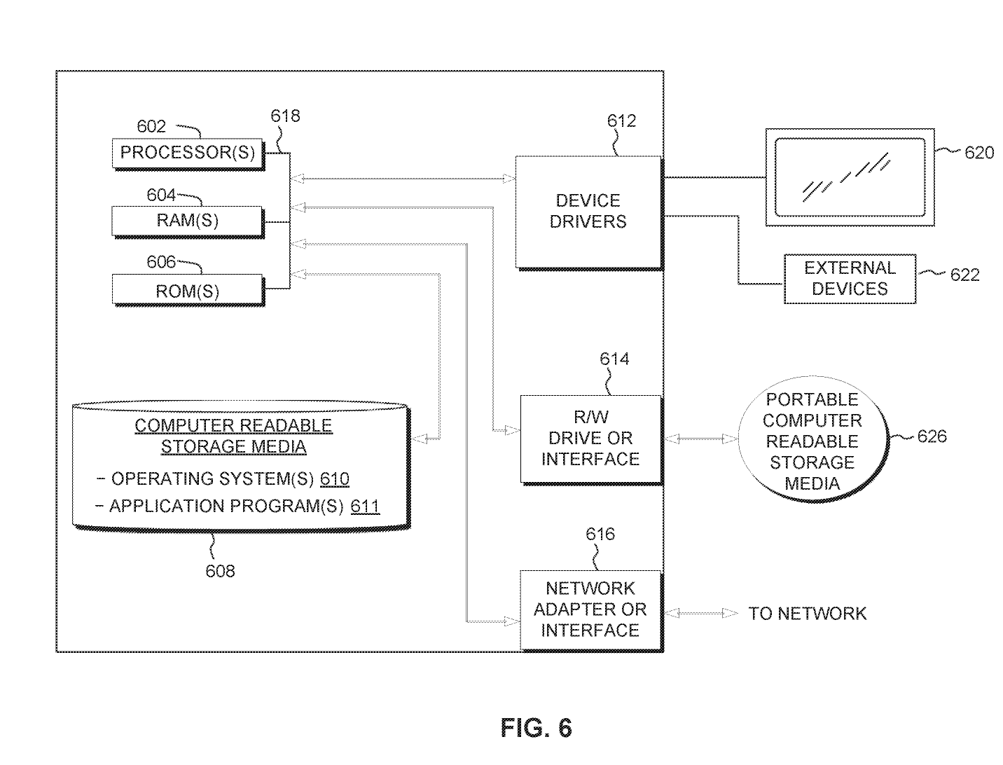

Computing device 110 includes user interface 116. In the example embodiment, computing device 110 is a computing device such as a smartphone, however in other embodiments, computing device 110 may be a desktop computer, a laptop computer, a tablet computer, a handheld device, a thin client, or any other electronic device or computing system capable of receiving and sending data to and from other computing devices, such as server 140, via network 130. Computing device 110 is described in more detail with reference to FIG. 6.

User interface 116 includes components to receive input from a user and transmit the input to an application residing on computing device 110. In the example embodiment, user interface 116 uses a combination of technologies and devices, such as device drivers, to provide a platform to enable users of computing device 110 to interact with an application on computing device 110.

Server 150 includes database 152. In the example embodiment, server 150 may be a desktop computer, a laptop computer, a tablet computer, a mobile device, a handheld device, a thin client, or any other electronic device or computing system capable of receiving and sending data to and from other computing devices, such as computing device 110, via network 130. Although not shown, optionally, server 150 can comprise a cluster of servers executing the same software to collectively process requests as distributed by a front end server and a load balancer. In the example embodiment, server 150 is a server that supports an application, however, in other embodiments; server 150 may be a server that supports a website or another program. Server 150 is described in more detail with reference to FIG. 6.

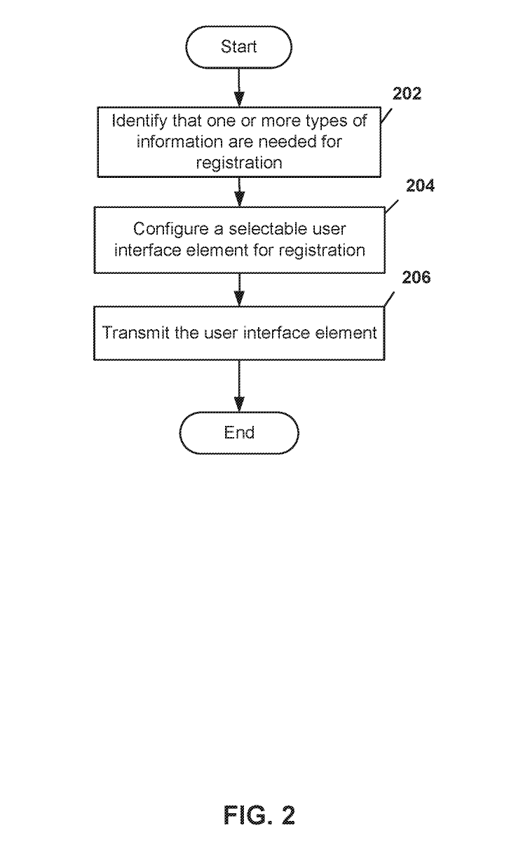

Database 152 includes electronic content/information corresponding to one or more users. In the example embodiment, database 152 may include information pertaining to one or more user accounts or content/records associated with one or more users, such as email accounts, social media accounts, financial accounts, text message content, public records, or any other form of user account or content. For example, database 152 may be an email database that includes a repository of emails received and transmitted by each user that has an account with a specific email provider. Database 152 is described in further detail with regard to FIGS. 2 through 4.

Service provider server 120 may be a desktop computer, a laptop computer, a tablet computer, a mobile device, a handheld device, a thin client, or any other electronic device or computing system capable of receiving and sending data to and from other computing devices, such as computing device 110, via network 130. Although not shown, optionally, service provider server 120 can comprise a cluster of servers executing the same software to collectively process requests as distributed by a front-end server and a load balancer. Service provider server 120 is described in more detail with reference to FIG. 6.

Server 140 includes identification program 142. Server 140 may be a desktop computer, a laptop computer, a tablet computer, a mobile device, a handheld device, a thin client, or any other electronic device or computing system capable of receiving and sending data to and from other computing devices, such as computing device 110, via network 130. Although not shown, optionally, server 140 can comprise a cluster of servers executing the same software to collectively process requests as distributed by a front-end server and a load balancer. Server 140 is described in more detail with reference to FIG. 6.

In the example embodiment, identification program 142 is a program capable of identifying one or more types of information needed to register for a service provided by service provider server 120. Furthermore, identification program 142 is capable of configuring a selectable user interface element that, when selected identifies one or more values corresponding to the one or more types of information needed for registration, and further transmits the one or more values to service provider server 120. In other embodiments, identification program 142 is capable of communicating with database 152 and determining whether one or more values for the one or more types of information can be identified, and based on determining that the one or more values can be identified, creating a selectable user interface element that contains the one or more values. The operations of identification program 142 are described in further detail with reference to FIG. 2 through 4.

FIG. 2 is a flowchart illustrating the operations of identification program 142 in creating a selectable user interface element for automating registration of a user with a service provider, in accordance with an embodiment.

In the example embodiment, identification program 142 identifies that one or more types of information are needed for registration for a service associated with service provider server 120 (step 202). In the example embodiment, identification program 142 may communicate with service provider server 120 via network 130 in order to determine the types of information required for registration for the service associated with service provider server 120. The service associated with service provider server 120 may include a payment provider application, a social media application, a financial application, a geolocation application, web service application, an entertainment application (such as a music application), or another type of service. In other embodiments, identification program 142 may identify the one or more types of information needed for registration for a plurality of service (which may be associated with multiple service providers) and store each respective one or more types of information in a database in association with the corresponding service provider for future reference.

In the example embodiment, identification program 142 generates and configures a selectable user interface element (step 204). In the example embodiment, the selectable user interface element is configured so that upon detection of a selection of the selectable user interface element by a user of computing device 110, identification program 142 communicates with databases and repositories (that may be associated with one or more entities), such as database 152, identifies, in real time, user information within the databases and repositories that is relevant to the user of computing device 110, and further identifies, in real time, one or more values corresponding to one or more types of information needed for registration of the service associated with service provider server 120. In some embodiments, the configured selectable user interface element may be a hyperlink, a uniform resource locator, or another form of document link.

In the example embodiment, identification program 142 transmits the configured selectable user interface element to computing device 110, via network 130 (step 206). In the example embodiment, identification program 142 may embed or associate the configured selectable user interface element with an advertisement, such as a banner ad. In another embodiment, the configured selectable user interface element may itself be an advertisement or a selectable element that is associated with a service. For example, the configured selectable user interface element may be a selectable electronic button advertising a specific electronic payment service. In another example, the configured selectable user interface element may be a hyperlink within a banner ad advertising a social media platform. In the example embodiment, identification program 142 may receive information describing the banner ad or advertisement desired to be constructed featuring the configured selectable user interface element, from service provider server 120. For example, if service provider server 120 supports a social media platform, service provider server 120 may provide information corresponding to visual, auditory, and/or interactive aspects/elements of a banner ad that will feature the configured selectable user interface element. Identification program 142 may then incorporate the configured selectable user interface element into the specified banner ad and then transmit the banner ad (including the configured selectable user interface element) to computing device 110 for display to the user of computing device 110 via user interface 116. In other embodiments, the identification program 142 may receive information from service provider server 120 describing visual, auditory, and/or interactive aspects or elements of the configured selectable user interface element. For example, identification program 142 may receive a specific phrase or advertisement that is desired by the service provider to be incorporated into the configured selectable user interface element. In this example, identification program 142 incorporates the desired phrase or advertisement into the configured selectable user interface element and transmits the configured selectable user interface element to computing device 110 for display. In further embodiments, identification program 142 may transmit the configured selectable user interface element to service provider server 120 where the configured selectable user interface element may be incorporated into an advertisement, such as a banner ad, and transmitted onward to computing device 110 for display.

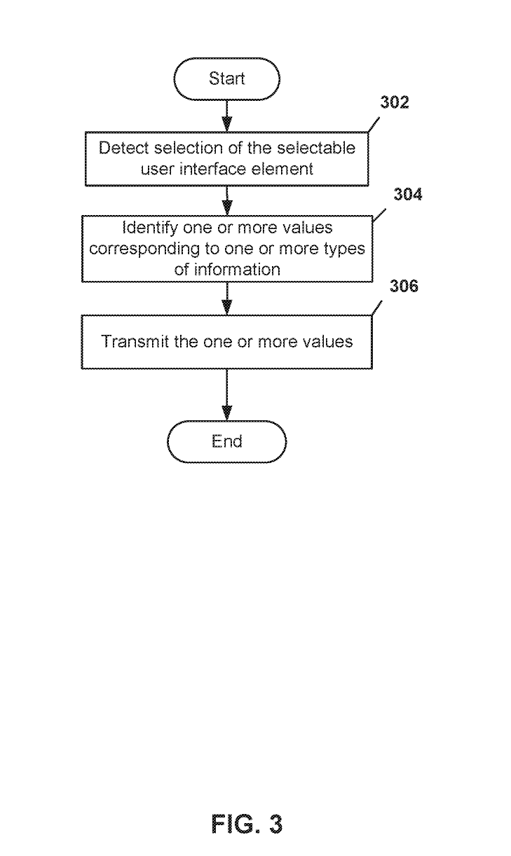

FIG. 3 is a flowchart illustrating the operations of identification program 142 in identifying one or more values corresponding to the one or more types of information required for registration of the service associated with service provider server 120, in accordance with an embodiment.

In the example embodiment, identification program 142 detects a selection of the configured selectable user interface element by the user of computing device 110 (step 302). In the example embodiment, identification program 142 detects the selection of the configured selectable user interface element by communicating with computing device 110 via network 130, or alternatively by monitoring the inputs received by computing device 110.

Responsive to detecting the selection of the configured selectable user interface element, identification program 142 identifies one or more values corresponding to the one or more types of information required for registration for the service associated with service provider server 120 (step 304). In the example embodiment, as described above, identification program 142 may access a database, such as database 152 (or a plurality of databases), in order to identify user information relevant to the user of computing device 110, and further identify one or more values corresponding to the one or more types of information required for registration for the service associated with service provider server 120. For example, if the one or more types of information required for registration for the service include an address, a phone number, and a last name, identification program 142 may access database 152 to identify information associated with the user of computing device 110 and further corresponding to the address, phone number and last name of the user of computing device 110. Further, if in the example, database 152 may be a an email server, and therefore, identification program 142 may utilize natural language processing techniques (or similar techniques) to search through email records (incoming and outgoing email) and identify the information corresponding to the address, phone number, and last name of the user of computing device 110. In another example, if the one or more types of information correspond to information relevant to performing a credit assessment of the user of computing device 110, identification program 142 may access database 152 information relevant to the one or more types of information required to perform a credit assessment.

Additionally, in some instances, identification program 142 may identify that multiple values potentially correspond to a type of information of the one or more types of information. For example, identification program 142 may utilize natural language processing techniques to identify, from database 152, two values that potentially correspond to the last name of the user of computing device 110. Identification program 142 may then determine a confidence score for each value to identify which value is more likely to be the last name of the user of computing device 110. Identification program 142 may identify a confidence score based on a number of times that a particular value has been utilized within the database or database or a number of documents that contain each value. In addition, identification program 142 may also assign a weight to each document and/or database, and determine a weight that corresponds to each particular instance of the value based on the document and/or database weights. Alternatively (or in addition to the above), identification program 142 may determine a weight to assign each particular instance that the value has been utilized based on additional factors such as an analysis of the substance of the document that contains each respective instance. Furthermore, identification program 142 may utilize probability distribution methods, such as a gamma distribution, Gaussian distribution, maximum likelihood estimator, or similar techniques, in order to determine a confidence score for each value.

In the example embodiment, identification program 142 may additionally compare each confidence score to a threshold score. If a confidence score for a value is below the threshold score, then identification program 142 determines the value does not correspond to the corresponding type of information. For example, if identification program 142 identifies that a first and second value corresponds to the last name of the user of computing device 110, and identification program 142 determines that the first value has a confidence score that is below the threshold score, identification program 142 removes the first value from consideration as being the last name of the user of computing device 110. In other embodiments, if multiple values are identified as potentially corresponding to a type of information (such as a last name of the user of computing device 110), identification program 142 compares only the value with the highest confidence score to the threshold score. If identification program 142 determines that the value with the highest confidence score exceeds the threshold score, identification program 142 associates the value with the corresponding type of information (such as the last name of the user of computing device 110). If identification program 142 determines that the value with the highest confidence score does not exceed the threshold score, identification program 142 may continue to search through additional databases for additional values corresponding to the type of information (and compare the additional value to the threshold score in the manner described above). If identification program 142 is unable to identify another value in the additional databases that has an associated confidence score that meets or exceeds the threshold score, identification program 142 may present the value (to service provider server 120) in association with the corresponding type of information, however, may provide an indication that the value may not be accurate. Alternatively, identification program 142 may prompt the user to provide the value (such as his/her last name).

Identification program 142 causes transmission of the one or more values corresponding to the one or more types of information required for registration for the service associated with service provider server 120 (step 306). In the example embodiment, responsive to identifying a value for each of the one or more types of information required for registration for the service associated with the service provider server 120, identification program 142 transmits the identified values to service provider server 120. Service provider server 120 may then utilize the identified values to register the user of computing device 110 for the service. With regard to a credit offer, the selectable user interface element may be configured to, upon selection, transmit information relevant to a performance of a credit assessment of the user of computing device 110 and cause service provider server 120 to identify whether or not the user qualifies for a credit offer. In other embodiments, even if a value is not identified for each of the one or more types of information, identification program 142 transmits the values that have been identified to correspond to the one or more types of information to service provider server 120. Additionally, identification program 142 may transmit information that includes an indication for the type of types of information where a value was not identified or for instances where a value identified to potentially correspond to a type of information did not meet or exceed the threshold score. In addition, in further embodiments, identification program 142 may include the confidence score associated with each of the identified values (the one or more values), and further may include the confidence score for each value identified to potentially correspond to a type of information, but was below the threshold score.

Furthermore, in the example embodiment, identification of the one or more values corresponding to the one or more types of information required for registration and transmission of the identified values to service provider server 120 are performed in response to detection of a selection of the configured selectable user interface element.

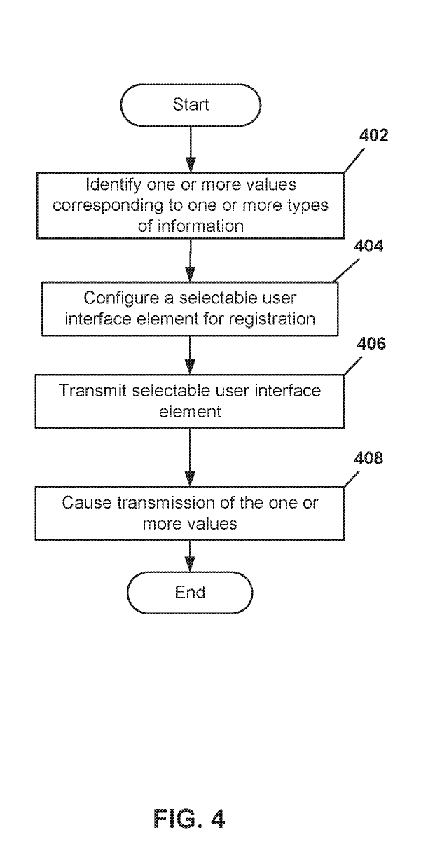

FIG. 4 is a flowchart illustrating an alternative embodiment of the operations of identification program 142 in creating a selectable user interface element for automating registration of a user with a service provider, in accordance with an embodiment.

In the example embodiment, identification program 142 identifies one or more values corresponding to the one or more types of information required for registration for the service associated with service provider server 120 (step 402). In the example embodiment, as described above with regard to FIG. 2, identification program 142 may communicate with service provider server 120 via network 130 in order to determine the types of information required for registration for the service associated with service provider server 120. In other embodiments, identification program 142 may identify the one or more types of information needed for registration for a plurality of service (which may be associated with multiple service providers) and store each respective one or more types of information in a database in association with the corresponding service provider for future reference.

In the example embodiment, as described above with regard to FIG. 3, identification program 142 may then access a database(s), such as database 152 (or a plurality of databases), in order to identify user information relevant to the user of computing device 110, and further identify one or more values corresponding to the one or more types of information required for registration for the service associated with service provider server 120. Additionally, as described above, in some instances, identification program 142 may identify that multiple values potentially correspond to a type of information of the one or more types of information. For example, identification program 142 may utilize natural language processing techniques to identify, from database 152, two values that potentially correspond to the last name of the user of computing device 110. Identification program 142 may then determine a confidence score for each value to identify which value is more likely to be the last name of the user of computing device 110. Identification program 142 may identify a confidence score based on a number of times that a particular value has been utilized within the database or database or a number of documents that contain each value. In addition, identification program 142 may also assign a weight to each document and/or database, and determine a weight that corresponds to each particular instance of the value based on the document and/or database weights. Alternatively (or in addition to the above), identification program 142 may determine a weight to assign each particular instance that the value has been utilized based on additional factors such as an analysis of the substance of the document that contains each respective instance. Furthermore, identification program 142 may utilize probability distribution methods, such as a gamma distribution, Gaussian distribution, maximum likelihood estimator, or similar techniques, in order to determine a confidence score for each value.

In the example embodiment, identification program 142 generates and configures a selectable user interface element (step 404). In the example embodiment, selectable user interface element is configured to include or be associated with the identified one or more values (for example, information describing the identified one or more values may be embedded in a hyperlink contained in the configured selectable user interface element). Furthermore, the selectable user interface element is configured so that upon selection of the selectable user interface element by a user of computing device 110, computing device 110 transmits the identified one or more values to service provider server 120. In some embodiments, the configured selectable user interface element may be a hyperlink, a uniform resource locator, or another form of document link.

In the example embodiment, identification program 142 transmits the configured selectable user interface element to computing device 110, via network 130 (step 406). In the example embodiment, as described above, identification program 142 may embed or associate the configured selectable user interface element with an advertisement, such as a banner ad. In another embodiment, the configured selectable user interface element may itself be an advertisement or a selectable element that is associated with a service. For example, the configured selectable user interface element may be a selectable electronic button advertising a specific electronic payment service. In another example, the configured selectable user interface element may be a hyperlink within a banner ad advertising a social media platform. In the example embodiment, identification program 142 may receive information describing the banner ad or advertisement desired to be constructed featuring the configured selectable user interface element, from service provider server 120. For example, if service provider server 120 supports a social media platform, service provider server 120 may provide information corresponding to visual, auditory, and/or interactive aspects/elements of a banner ad that will feature the configured selectable user interface element. Identification program 142 may then incorporate the configured selectable user interface element into the specified banner ad and then transmit the banner ad (including the configured selectable user interface element) to computing device 110 for display to the user of computing device 110 via user interface 116. In other embodiments, the identification program 142 may receive information from service provider server 120 describing visual, auditory, and/or interactive aspects or elements of the configured selectable user interface element. For example, identification program 142 may receive a specific phrase or advertisement that is desired by the service provider to be incorporated into the configured selectable user interface element. In this example, identification program 142 incorporates the desired phrase or advertisement into the configured selectable user interface element and transmits the configured selectable user interface element to computing device 110 for display. In further embodiments, identification program 142 may transmit the configured selectable user interface element to service provider server 120 where the configured selectable user interface element may be incorporated into an advertisement, such as a banner ad, and transmitted onward to computing device 110 for display.

Identification program 142 causes transmission of the identified one or more values to service provider server 120 (step 408). As stated above, identification program 142 configures the selectable user interface element so that upon selection of the selectable user interface element by a user of computing device 110, computing device 110 transmits the identified one or more values to service provider server 120. Therefore, upon selection of the configured selectable user interface element by the user of computing device 110, computing device 110 transmits the identified one or more values to service provider server 120. Service provider server 120 may then utilize the identified one or more values to automatically register the user of computing device 110 for the service. In some embodiments, an application, such as a web browser may perform the transmission of the identified one or more values to the service provider server.

In other embodiments, rather than being configured to transmit the identified one or more values (and including or associating the one or more values with the selectable user interface element), identification program 142 may configure the selectable user interface element to transmit an indication to identification program 142. Upon reception of the indication, identification program 142 may transmit the identified one or more values to service provider server 120. Alternatively, identification program 142 may monitor the actions taking place on computing device 110 via network 130, and upon detection that the configured selectable user interface element has been selected, identification program 142 may transmit the identified one or more values to service provider server 120.

In further embodiments, as discussed above, identification program 142 may configure the selectable user interface to not include or be associated with a value that has an associated confidence score that is below the threshold score. For example, if a first value corresponding to a last name of the user of computing device 110 has a confidence score that is below the threshold score, identification program 142 may configure the selectable user interface element to not include or be associated with the first value (and therefore not transmit the first value upon selection) or alternatively, may include or associate information with the selectable user interface element that indicates that the first value may not be accurate (and/or additionally include the confidence score). Furthermore, identification program 142 may prompt the user of computing device 110 to provide information pertaining to the last name of the user, as described above.

In addition, in further embodiments, prior to identification program 142 identifying the one or more values corresponding to the one or more types of information required for registration for a service associated with service provider server 120, identification program 142 may prompt the user for permission, such as, query the user as to whether the user approves the sharing of the values corresponding to the one or more types of information. For example, identification program 142 may prompt the user of computing device 110 as to whether the user approves of the sharing of the last name of the user and the address of the user. Additionally, identification program 142 may include information as to which service provider the information will be or may be shared with. In other embodiments, identification program 142 may prompt the user for his/her approval prior to configuring (or transmitting) the selectable user interface element.

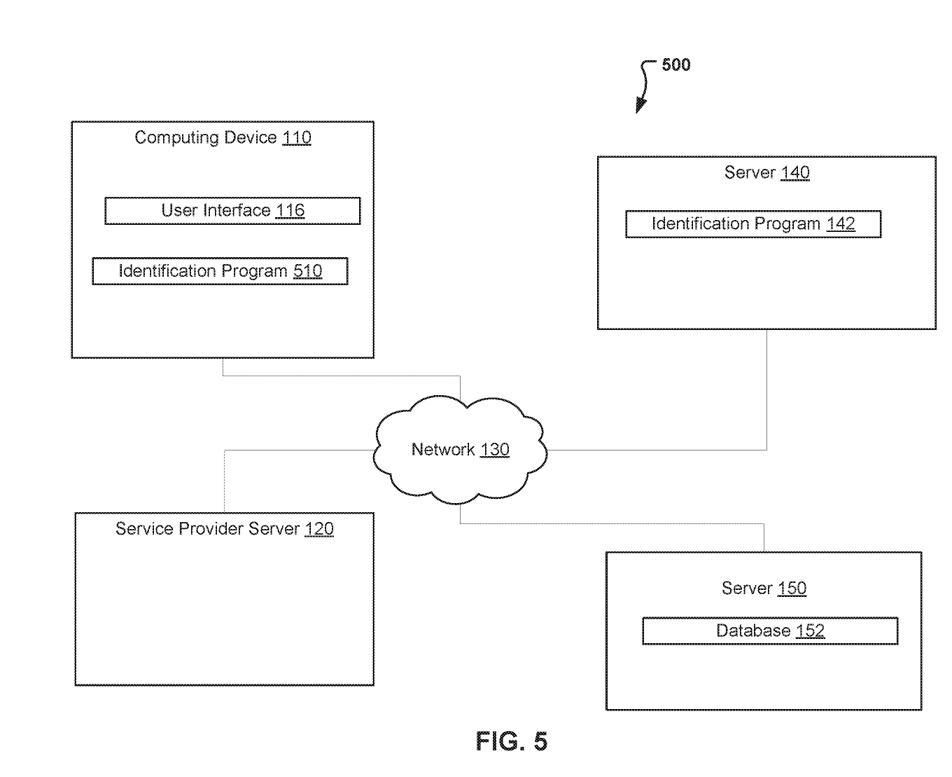

FIG. 5 illustrates identification system 500, in accordance with an embodiment. In the example embodiment, identification system 500 includes computing device 110, server 140, service provider server 120, and server 150 interconnected via network 130. Further, in the example embodiment, computing device 110 include identification program 510, which is a sister (or a child) program to identification program 142. In the example embodiment, identification program 142 may utilize identification program 510 to perform the monitoring of computing device 110, detection of selections on computing device 110, and further transmission of information by computing device 110 discussed above with reference to the flowcharts. Furthermore, identification program 510 may be utilized to identify the one or more values corresponding to the one or more types of information required for registration for the service associated with service provider server 120 by monitoring activity and analyzing information that is accessed by the user of computing device 110. For example, when the user of computing device 110 check his/her email, identification program 510 may monitor and analyze the contents of the respective email account that are being viewed or available locally.

In addition, in further embodiments, identification program 142 may be solely located locally on computing device 110, and may function in a similar manner as described above. In even further embodiments, identification program 142 may be located on service provider server 120, and may function in a similar manner as described in FIGS. 2 and 3. In additional embodiments, identification program 142 may be located on service provider server 120 and additionally have a sister program may be located on computing device 110, and may function in a similar manner as described in FIG. 5.

The foregoing description of various embodiments of the present disclosure has been presented for purposes of illustration and description. It is not intended to be exhaustive nor to limit the disclosure to the precise form disclosed. Many modifications and variations are possible. Such modifications and variations that may be apparent to a person skilled in the art of the disclosure are intended to be included within the scope of the disclosure as defined by the accompanying claims.

FIG. 6 depicts a block diagram of components of computing devices contained in identification system 100 of FIG. 1 and identification system 500 in FIG. 5, in accordance with an embodiment. It should be appreciated that FIG. 6 provides only an illustration of one implementation and does not imply any limitations with regard to the environments in which different embodiments may be implemented. Many modifications to the depicted environment may be made.

Computing devices may include one or more processors 602, one or more computer-readable RAMs 604, one or more computer-readable ROMs 606, one or more computer readable storage media 608, device drivers 612, read/write drive or interface 614, network adapter or interface 616, all interconnected over a communications fabric 618. Communications fabric 618 may be implemented with any architecture designed for passing data and/or control information between processors (such as microprocessors, communications and network processors, etc.), system memory, peripheral devices, and any other hardware components within a system.

One or more operating systems 610, and one or more application programs 611, for example, identification program 142, are stored on one or more of the computer readable storage media 608 for execution by one or more of the processors 602 and by utilizing one or more of the respective RAMs 604 (which typically include cache memory). In the illustrated embodiment, each of the computer readable storage media 608 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing devices may also include a R/W drive or interface 614 to read from and write to one or more portable computer readable storage media 626. Application programs 611 on the computing devices may be stored on one or more of the portable computer readable storage media 626, read via the respective R/W drive or interface 614 and loaded into the respective computer readable storage media 608.

Computing devices may also include a network adapter or interface 616, such as a TCP/IP adapter card or wireless communication adapter (such as a 4G wireless communication adapter using OFDMA technology). Application programs 611 on the computing devices may be downloaded to the computing devices from an external computer or external storage device via a network (for example, the Internet, a local area network or other wide area network or wireless network) and network adapter or interface 616. From the network adapter or interface 616, the programs may be loaded onto computer readable storage media 608. The network may comprise copper wires, optical fibers, wireless transmission, routers, firewalls, switches, gateway computers and/or edge servers.

Computing devices may also include a display screen 620, and external devices 622, which may include, for example a keyboard, a computer mouse and/or touchpad. Device drivers 612 interface to display screen 620 for imaging, to external devices 622, and/or to display screen 620 for pressure sensing of alphanumeric character entry and user selections. The device drivers 612, R/W drive or interface 614 and network adapter or interface 616 may comprise hardware and software (stored on computer readable storage media 608 and/or ROM 606).

The programs described herein are identified based upon the application for which they are implemented in a specific embodiment. However, it should be appreciated that any particular program nomenclature herein is used merely for convenience, and thus the disclosure should not be limited to use solely in any specific application identified and/or implied by such nomenclature.

Based on the foregoing, a computer system, method, and computer program product have been disclosed. However, numerous modifications and substitutions can be made without deviating from the scope of the present disclosure. Therefore, the various embodiments have been disclosed by way of example and not limitation.

Various embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A system of a first entity, comprising:
a non-transitory memory; and
one or more hardware processors coupled to the non-transitory memory and configured to read instructions from the non-transitory memory to cause the system to perform operations comprising:
determining that one or more types of information are required for registering a user for a service associated with a service provider; and
configuring a selectable hyperlink to:
upon selection, analyze electronic content in one or more databases associated with a second set of entities to identify, from the electronic content, one or more values associated with the user, the one or more values corresponding to the one or more types of information, and wherein the first entity is different from the second set of entities, and
cause the one or more values to be transmitted to the service provider.

2. The system of claim 1, wherein the operations further comprise:
transmitting the configured selectable hyperlink to a device of the user to cause display of the configured selectable hyperlink to the user in association with an advertisement associated with the service provider.

3. The system of claim 1, wherein the analyzing the electronic content to identify, from the electronic content, the one or more values associated with user comprises:
determining a certainty score for a first value of the one or more values, the first value corresponding to a first type of information of the one or more types of information;
in response to determining that the certainty score for the first value does not exceed a threshold score, analyzing additional electronic content to identify a second value associated with the user that corresponds to the first type of information;
in response to determining that a certainty score for the second value exceeds the threshold score, removing the first value from the one or more values, and adding the second value to the one or more values.

4. The system of claim 1, wherein the analyzing the electronic content to identify, from the electronic content, the one or more values associated with user comprises:
determining a certainty score for each of the one or more values; and
wherein each of the one or more values transmitted to the service provider have a corresponding certainty score that meets or exceeds a threshold score.

5. The system of claim 1, wherein the certainty score for each of the one or more values is determined by utilizing a probability distribution method.

6. The system of claim 1, wherein the electronic content is content selected from a group consisting of: email content, social media content, text message content, and public record content.

7. The system of claim 1, wherein the causing the one or more values to be transmitted to the service provider further comprises causing the service provider to automatically register the user for the service associated with the service provider.

8. (canceled)

9. A method comprising:
determining that one or more types of information are required for a user to register for a service associated with a service provider;
accessing one or more databases associated with one or more entities to identify one or more values associated with the user, the one or more values corresponding to the one or more types of information; and
in response to the identifying the one or more values associated with the user, configuring a selectable hyperlink to, upon selection, cause transmission of the one or more values to the service provider.

10. The method of claim 9, wherein the determining that the one or more types of information are required for registering the user for a service associated with the service provider includes communicating with a service provider server to identify that the one or more types of information are required for registering the user for the service.

11. The method of claim 9, wherein the accessing the one or more databases associated with the one or more entities to identify the one or more values associated with the user includes:
determining a certainty score for a first value, the first value predicted to correspond to a first type of information of the one or more types of information;
determining a certainty score for a second value, the second value predicted to correspond to the first type of information;
in response to determining that the certainty score of the first value is higher than the certainty score of the second value, associating the first value with the first type of information and including the first value in the one or more values.

12. The method of claim 11, further comprising determining that the certainty score of the first value meets or exceeds a threshold score.

13. The method of claim 11, wherein determining the certainty score for the first value further comprises identifying a number of instances that the first value is contained in one or more documents in the one or more databases, and further associating a weight to each of the one or more documents.

14. The method of claim 11, wherein determining the certainty score for the first value further comprises identifying a number of documents of one or more documents in the one or more databases that contain the first value, and further associating a weight to each of the one or more documents.

15. The method of claim 9, transmitting the configured selectable hyperlink to a device of the user to cause display of the configured selectable hyperlink to the user in an advertisement associated with the service provider.

16. The method of claim 9, wherein the causing the one or more values to be transmitted to the service provider further comprises causing the service provider to automatically register the user for the service associated with the service provider.

17. The method of claim 9, wherein the determining that one or more types of information are required for a user to register with a service provider further comprises storing information describing the one or more types of information in a database in association with the service provider.

18. A non-transitory machine-readable medium having stored thereon machine-readable instructions executable to cause a machine to perform operations comprising:
receiving a selection of a selectable hyperlink from a user;
in response to the selection, accessing electronic content in one or more databases associated with one or more entities;
determining, from the electronic content, one or more values associated with the user, the one or more values corresponding to one or more types of information that was required for the user to be registered for a service associated with a service provider, and wherein the one or more entities is different from the service provider, and
the one or more values to be transmitted to the service provider.

19. The non-transitory machine-readable medium of claim 18, wherein the causing the one or more values to be transmitted to the service provider further comprises causing the service provider to automatically register the user for the service associated with the service provider.

20. The non-transitory machine-readable medium of claim 19, wherein the determining includes:
determining a certainty score for a first value, the first value predicted to correspond to a first type of information of the one or more types of information;
determining a certainty score for a second value, the second value predicted to correspond to the first type of information; and
in response to determining that the certainty score of the first value is higher than the certainty score of the second value, associating the first value with the first type of information and including the first value in the one or more values.

21. The method of claim 9, wherein accessing one or more databases comprises:
analyzing records of the one or more databases using natural language processing to identify information in the records corresponding to the one or more types of information.
